(19) United States
(12) Patent Application Publication
(10) Pub. No.: US 2023/0405451 A1
(43) Pub. Date: Dec. 21, 2023

(54) Self-Improvement Game

(71) Applicant: Myles Cornwall, Oxford Mills (CA)

(72) Inventor: Myles Cornwall, Oxford Mills (CA)

(21) Appl. No.: 17/841,446

(22) Filed: Jun. 15, 2022

(51) Int. Cl. A63F 11/00; A63F 3/00; A63F 1/04

(52) U.S. Cl. CPC A63F 11/0051; A63F 3/00006; A63F 2003/00018; A63F 2011/0067; A63F 2001/0441; A63F 1/04

(57) ABSTRACT

The weekly clock in hours is the only board game of its kind that is specifically created to help individuals remain steadfast in the pursuit of their goals. This unprecedented product is uniquely designed with diverse reflection and moving forward cards that are developed to motivate users to persevere and utilizes cutting-edge organizational tools, such as: a notepad calendar and weekly check in hour metrics, that guarantees users are able to better plan and manage their time as they accomplish their agendas.

### BACKGROUND

Setting goals is easy, the difficult and challenging part however is in the execution and the consistency of one's commitment. In fact, most people fail to live their dream life because they often don't stick to their goals and plans, finding themselves overwhelmed by daily responsibilities and/or easily distracted. There have been no products available as original equipment or as an aftermarket to address this problem.

An apparatus that through play you can practice and implement goal setting, commitment and responsibilities is not being met by any known device or system at present. There have been no products available as original equipment or as an aftermarket to address this problem either.

### SUMMARY OF THE INVENTION

The main purpose of the self-improvement game is to provide users with a personal achievement board game that helps individuals reach the goals and desires they set forth to accomplish.

A board game disclosed includes a score sheet comprising multiple rows for accepting a plurality of labels of tasks and multiple columns intersecting therewith for accepting a plurality of labels of achievement types. The board game also includes a calendar notepad comprising multiple rows for accepting calendar dates, and multiple columns intersecting therewith for accepting a number of hours spent on the plurality of tasks per a given week of calendar dates. The board game further includes a game board configured to keep score of a players game piece in relation to the plurality of hours spent on each of the plurality of tasks.

### BRIEF DESCRIPTION OF THE DRAWINGS

FIG. 1 is a top elevational view of the self-improvement game in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

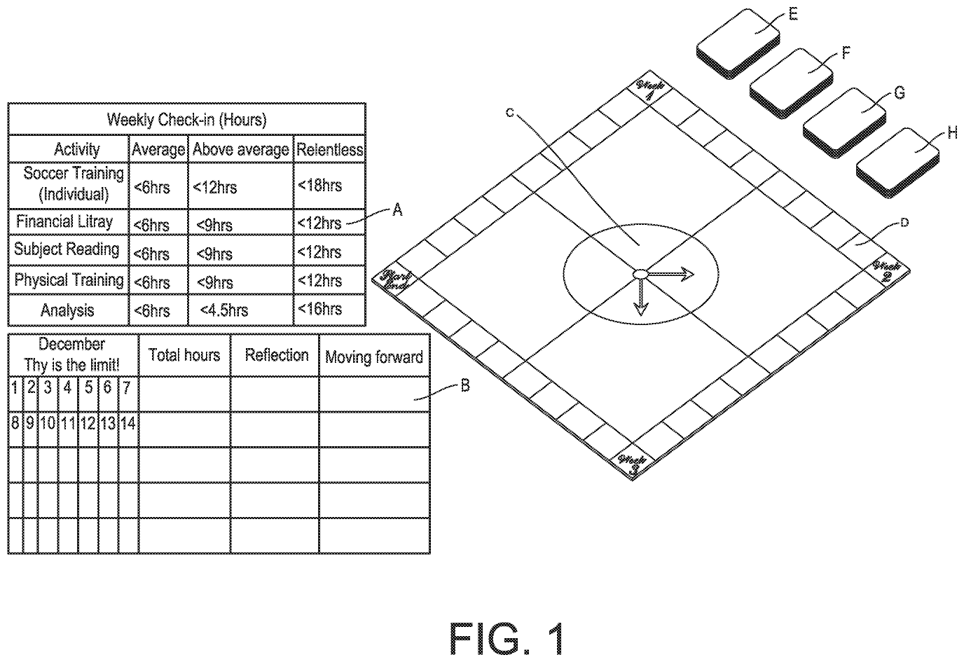

FIG. 1 is a top elevational view of the self-improvement game showing: weekly check-in hours referenced as A, notepad calendar referenced as B, weekly clock-in hours referenced as C, board game referenced as D, reflection cards referenced as E, moving forward cards referenced as F, total hours cards referenced as G, and questions referenced as H, in accordance with an embodiment of the present disclosure.

The present disclosed self-improvement game also known as “The Weekly Clock in Hours” offers a modern accessory that intends to motivate individuals to stick to their plans, work on their goals, and take action even when they don't feel like it. Expanding on the initial design of an average board game, the weekly clock in hours introduces a novel personal achievement board game that functions as a to-do list for any hobby, activity, or responsibility that an individual may want to commit to while offering an element of competition amongst peers or a source of independent challenge. Users simply write down the activities that they either want to implement more of, or remain consistent in, and identify the time frame that they will dedicate to the goal, based on a three level system: average (investment of 2.5 hours), above average (investment of 5 hours), and relentless (investment of 7.5 hours). From there, users can work on what they've written down, committing to a certain number of hours per day to see the results accrue per week. At the end of each week/off day, individuals can calculate how many hours they put forth for the given week, reflect on what they excelled in, and things to be mindful of moving forward. Through this process, consumers will be able to learn more about their commitment patterns, have better management strategies, and create time for the essential self-improvement activities they so desire. The weekly clock in hours motivates individuals to stay committed and inspired to reach their goals.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A board game comprising:
a score sheet comprising multiple rows for accepting a plurality of labels of tasks and multiple columns intersecting therewith for accepting a plurality of labels of achievement types;
a calendar notepad comprising multiple rows for accepting calendar dates, and multiple columns intersecting therewith for accepting a number of hours spent on the plurality of tasks per a given week of calendar dates; and
a game board configured to keep score of a players game piece in relation to the plurality of hours spent on each of the plurality of tasks.

2. The board game of claim 1, further comprising a stack of personal reflection cards.

3. The board game of claim 1, further comprising a stack of moving forward cards.

4. The board game of claim 1, further comprising a stack of preforecasted total hours cards.

5. The board game of claim 1, further comprising a stack of self improvement question cards.

6. The board game of claim 1, wherein the game board further comprises a single arrow spinner rotatably anchored in a center thereof representing hours of a day.

7. The board game of claim 1, wherein the game board further comprises a two arrow spinner rotatably anchored in a center thereof respectively representing a time of a day.

8. The board game of claim 1, wherein the plurality of task labels include Exercise, Finances, Reading, Sports, and Analysis.

9. The board game of claim 1, wherein the plurality of achievement type labels include Average, Above Average and Relentless.

10. The board game of claim 1, wherein the calendar notepad further comprises multiple column headings for accepting personal reflection notes and moving forward notes.

11. The board game of claim 1, wherein the game board further comprises a sectioned path disposed at a perimeter thereof.

12. The board game of claim 1, wherein the game board further comprises four corners thereof each labeled consecutively with a week of a month.

13. The board game of claim 1, wherein the score sheet accounts for a weekly number of hours checked in and completed for each of the plurality of tasks.

14. The board game of claim 1, wherein the multiple rows of the calendar notepad comprise five rows corresponding to five weeks in a month.

15. The board game of claim 1, wherein the multiple columns of the score sheet comprise three columns prepopulated with a forecasted number of hours to complete each of the plurality of tasks.

16. The board game of claim 1, further comprising a sectioned path at a perimeter of the game board with sections relative to a number of hours spent on each of the plurality of tasks.

17. The board game of claim 1, wherein the score sheet is a ‘to do list’ for one person.

18. The board game of claim 1, wherein the score sheet is a ‘to do list’ for a number of peers.

19. The board game of claim 1, wherein one of the multiple columns of the calendar notepad accepts a total number of hours spent on each of the tasks per a given week.

20. The board game of claim 1, wherein a sectioned path at a perimeter of the game board keeps score of a players game piece in relation to a monthly number of hours spent on each of the tasks
